(19) United States
(12) Patent Application Publication
(10) Pub. No.: US 2007/0014220 A1
(43) Pub. Date: Jan. 18, 2007

(54) Optical disc device

(75) Inventor: Naoki Ozaki, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/486,006

(22) Filed: Jul. 14, 2006

(30) Foreign Application Priority Data
Jul. 15, 2005 (JP) 2005-207304

(51) Int. Cl. G11B 5/09

(52) U.S. Cl. 369/59.25; 369/47.1

(57) ABSTRACT

An optical disc device has a header field detector configured to detect a header field of an optical disc, a header address information detector which detects a plurality of address information recorded to the header field, a range setting unit configured to set a range predicted that the plurality of address information is present within the header field, a position determination unit configured to determine whether the plurality of address information detected by the header address information detector is present within the range set by the range setting unit, and a starting position prediction unit configured to predict a starting position to be assessed in a recording field arranged subsequent to the header field in the optical disc and a sector address corresponding to the header field based on a determination result of the position determination unit.

### CROSS REFERENCE TO RELATED APPLICATIONS

This application is based upon and claims the benefit of priority from the prior Japanese Patent Application No. 2005-207304, filed on Jul. 15, 2005, the entire contents of which are incorporated herein by reference.

### BACKGROUND OF THE INVENTION

1. Field of the Invention

The present invention relates to an optical disc device performing recording/reproduction of an optical disc having a header field and a recording field successively disposed thereon.

2. Related Art

In DVD-RAM known as one type of optical disc, information is recorded in units of sector, and each sector is provided with the header field and the recording field. There has been proposed a processing operation in which, when recording and reproduction of DVD-RAM is performed, PID (Physical ID) within the header field is detected and an error determination thereof is performed, and based on the determination result, it is determined whether or not the sector address is correct (refer to Japanese Patent Laid-Open No. 11-213392).

A plurality of PIDs are provided within a header field. However, due to reproduction of an inferior disc or effects of disturbances etc. at the time of reproduction, all the PID data may be mistakenly detected, and as a result, it may be mistakenly determined that there is no error. In this case, a sector address is mistakenly defined, and it may be impossible to perform a normal recording and reproduction processing.

Also, since a starting position of recording field is predicted based on a detection result of PID, when PID is misidentified as described above, it is impossible to correctly predict the starting position.

### SUMMARY OF THE INVENTION

According to one embodiment of the present invention, an optical disc device, comprising:

a header field detector configured to detect a header field of an optical disc;

a header address information detector which detects a plurality of address information recorded to the header field;

a range setting unit configured to set a range predicted that the plurality of address information is present within the header field;

a position determination unit configured to determine whether the plurality of address information detected by the header address information detector is present within the range set by the range setting unit; and

a starting position prediction unit configured to predict a starting position to be assessed in a recording field arranged subsequent to the header field in the optical disc and a sector address corresponding to the header field based on a determination result of the position determination unit.

According to one embodiment of the present invention, an optical disc device, comprising:

a header field detector configured to detect a header field of an optical disc;

a header address information detector configured to detect a plurality of address information recorded to the header field;

a range setting unit configured to set a range in the header field predicted that the remaining address information within the header field is present, based on an interval from a position of a part of the address information detected by the header address information detector;

a position determination unit configured to determine whether a plurality of address information detected by the header address information detector is present within a range set by the range setting unit; and

a starting position prediction unit configured to predict a starting position to be accessed in a recording field arranged subsequent to the header field in the optical disc.

An optical disc device, comprising:

a header region detector configured to detect a header field of an optical disc;

a header address information detector configured to detect a plurality of address information recorded to the header field;

a first range setting unit configured to set a range predicted that the plurality of address information is present within the header field;

a first position determination unit configured to determine whether the plurality of address information detected by the header address information detector is present within a range set by the first range setting unit;

a second range setting unit configured to set a range in the header field predicted that the remaining address information in the header region is present based on an interval from a position of a part of the address information detected by the header address information detector;

a second position determination unit configured to determine whether a plurality of address information detected by the header address information detector is present within a range set by the second range setting unit;

a determination result selector configured to select at least one of a determination result of the first position determination unit and a determination result of the second position determination unit; and

a starting position prediction unit configured to predict a starting position to be accessed in a recording field arranged subsequent to the header field in the optical disc based on a determination result of the determination result selector.

### BRIEF DESCRIPTION OF THE DRAWINGS

FIG. 1 is a block diagram showing a schematic configuration of the major part of an optical disc device according to one embodiment of the present invention;

FIG. 2 is a block diagram showing a schematic configuration of the optical disc device according to the present embodiment;

FIG. 3 is a view showing an exemplary timing of header field signal and PIDnOK pulse;

FIG. 4 is a block diagram showing internal configurations of an address information position determination unit 25 and an address information interval measurement unit 26;

FIG. 5 is a view showing a track layout of DVD-RAM;

FIG. 6 is a view showing a detailed format of header field;

FIG. 7 is a view showing an example in which, within an identical header field, PID1OK pulse is detected twice and other PIDnOK pulses are not detected;

FIG. 8 is a timing diagram showing an example of setting a prediction window;

FIG. 9 is a timing diagram according to a second embodiment;

FIG. 10 is a timing diagram when PIDnOK pulses do not appear within the corresponding prediction windows; and

FIG. 11 is a timing diagram when some PIDnOK pulses do not appear within interval measurement windows.

### DETAILED DESCRIPTION OF THE INVENTION

An embodiment of the present invention will be described below with reference to drawings.

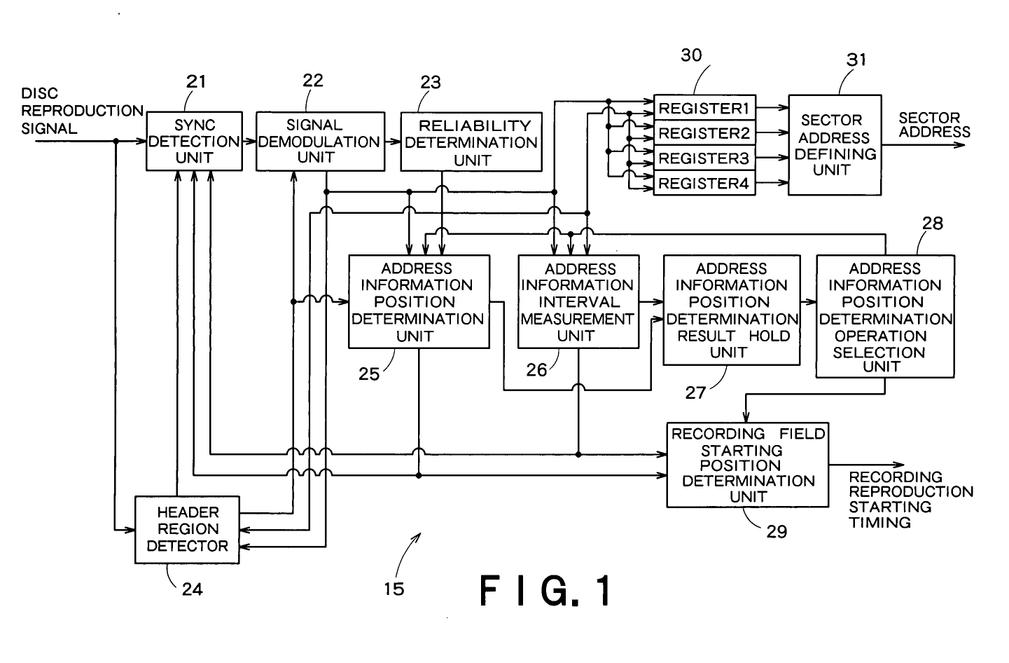

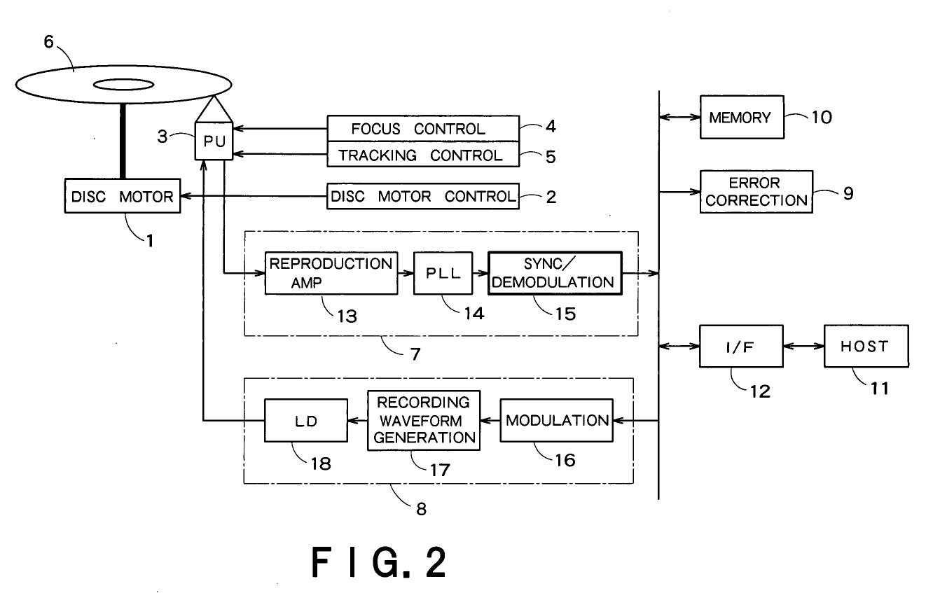

FIG. 1 is a block diagram showing a schematic configuration of a major part of an optical disc device according to one embodiment of the present invention. FIG. 2 is a block diagram showing a schematic configuration of the optical disc device according to the present embodiment.

First, the schematic configuration of the optical disc device will be described with reference to FIG. 2. The optical disc device of FIG. 2 includes a disc motor 1, a disc motor control unit 2, an optical pickup head (PU) 3, a focus control unit 4 which performs focus adjustment control of the optical pickup head 3, a tracking control unit 5 which performs position control in track direction of the optical pickup head 3, a reproduction control unit 7 which performs reproduction control of an optical disc 6, a recording control unit 8 which performs recording control of the optical disc 6, an error correction unit 9 which performs error correction of data read from the optical disc 6, a memory 10 which stores an error correction result and the like, and an interface unit 12 which communicates with a host computer 11.

The reproduction control unit 7 includes a reproduction amplifier 13, a PLL circuit 14, and a sync/demodulation unit 15 whose detailed configuration is shown in FIG. 1. The recording control unit 8 includes a modulation unit 16, a recording waveform generation unit 17 and a laser control unit (LD) 18.

The configuration of the sync/demodulation unit 15 constituting a characteristic part of the present embodiment will be described hereinafter with reference to FIG. 1. The sync/demodulation unit 15 of FIG. 1 includes a sync detection unit 21, a signal demodulation unit 22, a reliability determination unit 23, a header field detection unit 24, an address information position determination unit 25, an address information interval measurement unit 26, an address information position determination result hold unit 27, an address information position determination operation selection unit 28, a recording field starting position determination unit 29, a PID hold unit 30 and a sector address defining unit 31.

A disc reproduction signal read by the optical pickup head 3 is supplied to the sync detection unit 21 and the header field detection unit 24. The header field detection unit 24 detects a header field based on the disc reproduction signal. The sync detection unit 21 detects an AM pattern within the header field. This AM pattern is a sync signal, and each unit in the rear stage side of the sync detection unit 21 performs processings in synchronization with the AM pattern.

The signal demodulation unit 22 demodulates the disc reproduction signal to generate ID specifying an optical disc sector address. In this example, four types of PIDs (Physical IDs) are generated. The reliability determination unit 23 performs syndrome operation determination of the demodulated signal and generates PIDnOK pulses (n=1 to 4) indicating that PIDs have been detected.

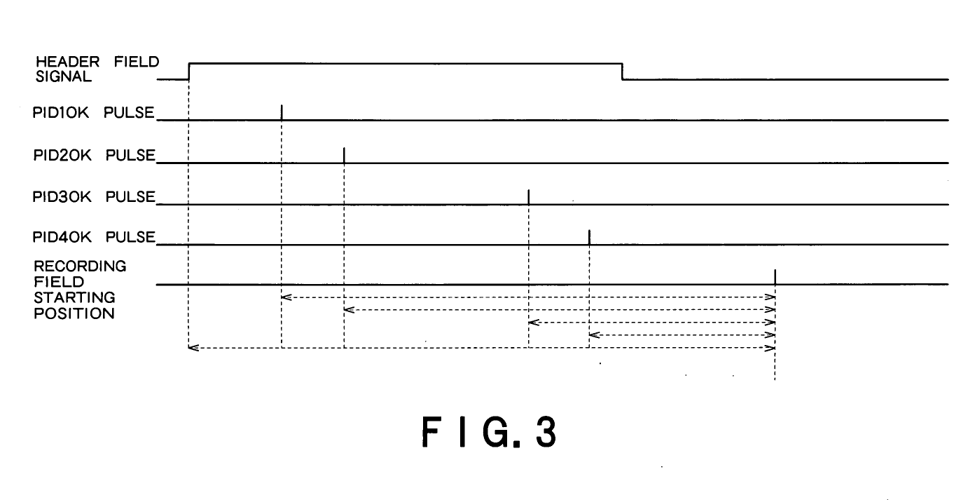

FIG. 3 is a view showing an exemplary timing of a header field signal indicating the header field and the PIDnOK pulses. As shown in FIG. 3, usually, each of PID1OK pulse, PID2OK pulse, PID3OK pulse and PID4OK pulse is detected one by one within an identical header field. The starting position of the recording field to be accessed is predicted based on the four PIDnOK pulses (n=1 to 4),

When detecting PID, the header field detection unit 24 in FIG. 1 adjusts a timing of a header field signal. When the header field signal is not detected, a flywheel operation is performed so as to keep the preceding timing.

The recording field starting position determination unit 29 predicts the starting position to be accessed in the recording field in synchronization with a channel clock generated according to wobble of the optical disc 6, based on the PIDnOK pulses. Recording or reproduction is performed from this starting position.

The address information position determination unit 25 sets a prediction window within the header field and determines whether or not PIDnOK pulse is present within the prediction window. The setting of prediction window may be performed by the header field detection unit 24.

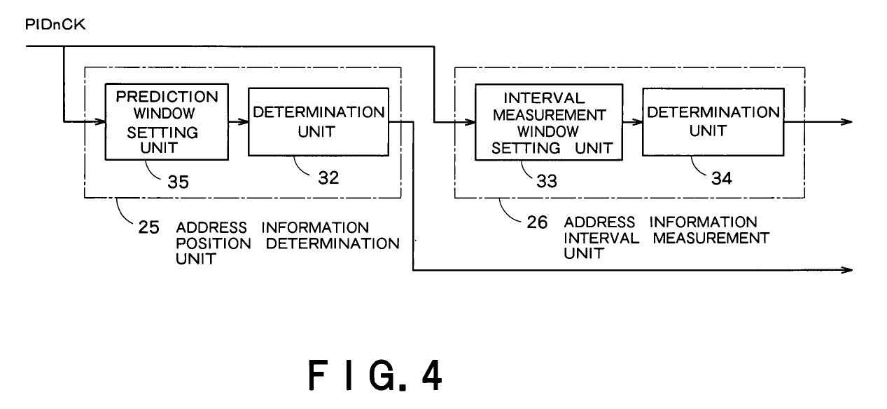

FIG. 4 is a block diagram showing internal configurations of the address information position determination unit 25 and the address information interval measurement unit 26. As shown in FIG. 4, the address information position determination unit 25 has a prediction window setting unit 35 and a determination unit 32. The prediction window setting unit 35 sets a prediction window within the header field representing a range predicted that the PIDnOK pulses appear. The determination unit 32 determines whether or not the PIDnOK pulses appear within the prediction window.

As shown in the internal configuration of FIG. 4, the address information interval measurement unit 26 has an interval measurement window setting unit 33 and a determination unit 34. The interval measurement window setting unit 33 detects an interval from a previously detected PIDnOK pulse to the other PIDnOK pulse subsequently appeared, and sets an interval measurement window for each interval detected. The determination unit 34 determines whether or not the PIDnOK pulses appear within the interval measurement window.

The address information position determination result hold unit 27 of FIG. 1 stores a result of detecting the adjacent or previous PIDnOK pulses. More specifically, a determination result of the address information position determination unit 25 and a determination result of the address information interval measurement unit 26 are stored.

The address information position determination operation selection unit 28 selects either of a determination result by the address information position determination unit 25 or a determination result by the address information interval measurement unit 26.

The PID hold unit 30 stores the PID having reliability guaranteed by the reliability determination unit 23. The sector address defining unit 31 defines a sector address based on the PID stored in the PID hold unit 30 and determination results of the address information position determination unit 25 and the address information interval measurement unit 26.

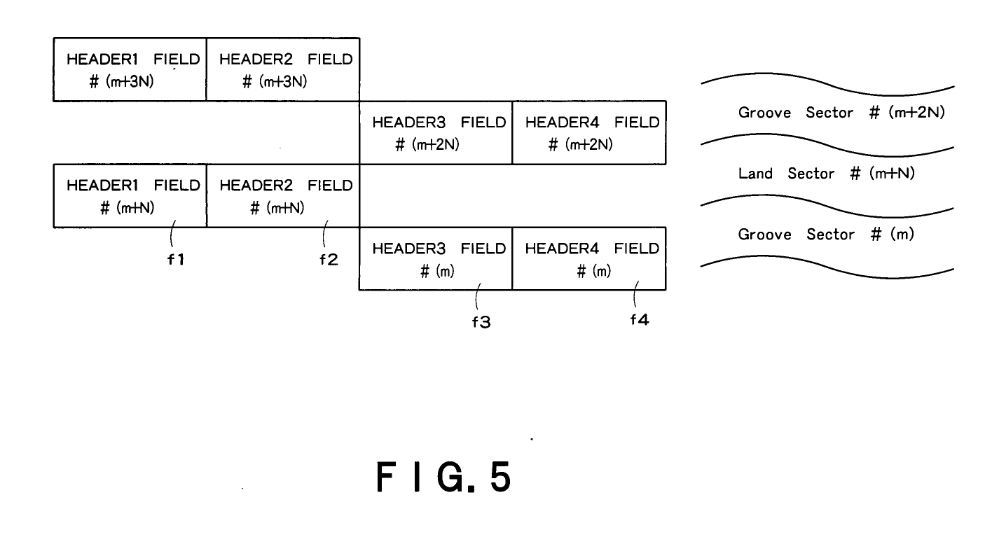

FIG. 5 is a view showing a track layout of DVD-RAM. In DVD-RAM, a header field is provided for each sector. Each header field has four header fields f1 to f4. Four header fields f1 to f4 are sorted into two pairs, and each pair is staggered by one half track relative to Land Track and Groove Track constituting the recording field. The paired two header fields (f1, f2) and (f3, f4) have identical PIDs, respectively. For example, when PIDs of four header fields are #(m+N), #(m+N), #(m) and #(m), then the sector address is #(m).

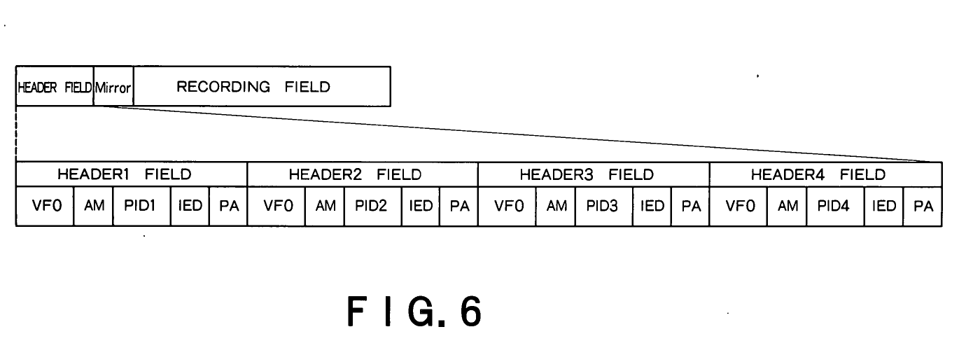

FIG. 6 is a view showing a detailed format of header field. Each of four header fields constituting the header field has five pieces of information: VF0, AM, PIDn (n being 1 to 4), IED and PA. Among these, AM is an AM pattern for synchronization, and IED is an ID error detection code for determining a PID demodulation result.

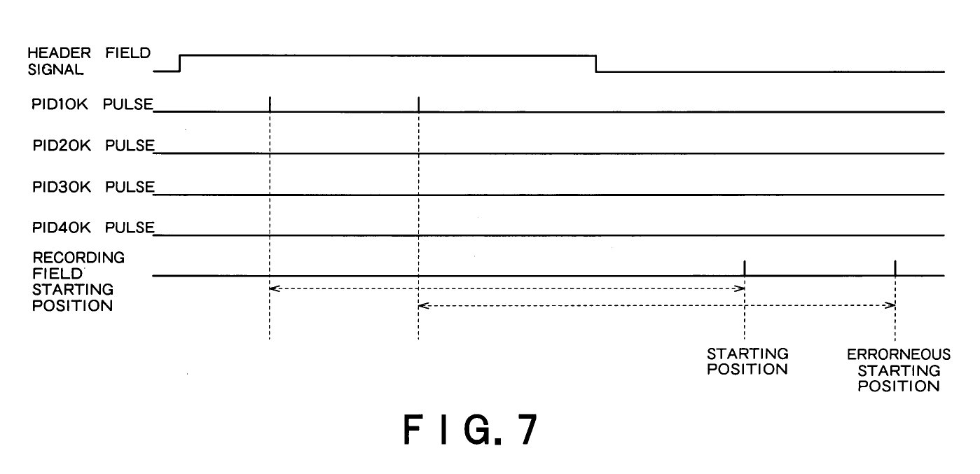

When a reproduction processing of DVD-RAM disc is performed, due to effects of environmental disturbances, inferiority of the disc or the like, the quality level of a signal supplied to the sync/demodulation unit 15 may be low. In this case, the same PIDnOK pulse (for example, PID1OK pulse) within the same header field may be detected plural times. For example, FIG. 7 shows an example in which the PID1OK pulse is detected twice and other PIDnOK pulses (n=2 to 4) are not detected within the same header field. In this case, the starting position in the recording field is predicted based on the detected PID1OK pulse. However, since PID1OK pulse has been detected twice, the recording field starting position cannot be properly predicted.

Thus, according to the present embodiment, to determine whether or not the position of PIDnOK pulse is correct, it is detected whether or not PIDnOK pulse appears within a prediction window set by the address information position determination unit 25.

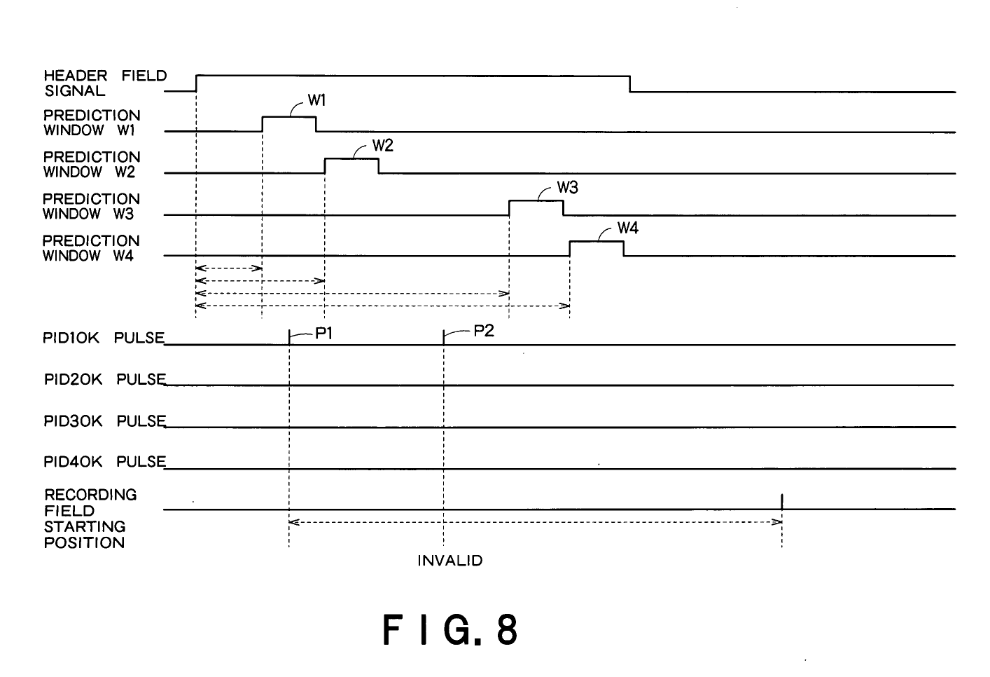

FIG. 8 is a timing diagram showing an example of setting a prediction window. In the case of FIG. 8, the PID1OK pulse p1 is present within prediction window w1 for PID1. Therefore, it is determined that the position of this pulse is correct. This determination is performed by the address information position determination unit 25 of FIG. 1. Meanwhile, as for the subsequent PID1OK pulse p2, prediction window w1 is not present at the position corresponding to the PID1OK pulse p2. Therefore, it is determined to be invalid.

In FIG. 8, no PIDnOK pulse is present at the positions of the prediction windows w2 to w4 corresponding to the other PIDnOK pulses (n=2 to 4). However, it is possible to correctly predict the starting position of the recording field based on the PID1OK pulse determined to be correct.

In this manner, according to the first embodiment, a prediction window is preliminarily set at a position where PIDnOK pulse is predicted to appear, and according to whether or not PIDnOK pulse appears within the prediction window, it is determined whether or not the position of PIDnOK pulse is normal. Therefore, a recording field starting position and sector address can be properly predicted.

In the first embodiment described above, position determination of PIDnOK pulses is performed based on a determination result of the address information position determination unit 25 of FIG. 1. Therefore, the address information interval measurement unit 26 may be omitted. In this case, the address information position determination operation selection unit 28 sends a signal in accordance with the determination result of the address information position determination unit 25 to the recording field starting position determination unit 29, instead of performing selection operation.

### Second Embodiment

According to a second embodiment, in addition to the prediction window, an interval measurement window is set to perform position determination of PIDnOK pulse.

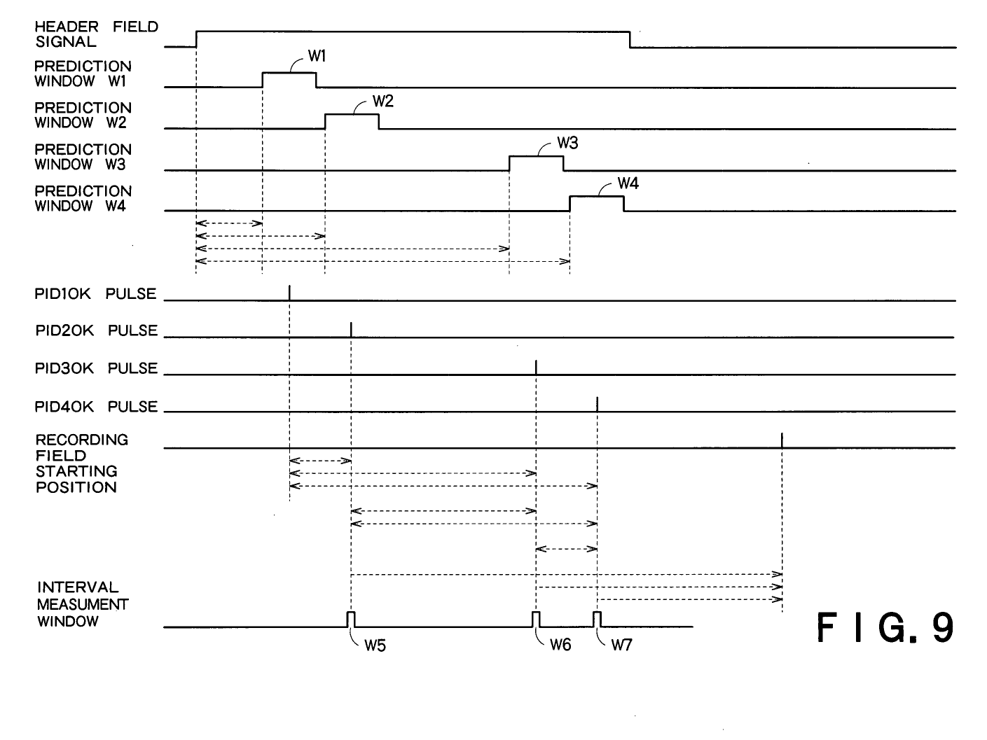

FIG. 9 shows a timing diagram according to the second embodiment. In the address information interval measurement unit 26 of FIG. 1, an interval is predicted from a time at which the PID1OK pulse is detected for the first time to a time at which subsequent PIDnOK pulses (n=2 to 4) appears, and then interval measurement windows w5 to w7 are set at the predicted interval positions. These interval measurement windows w5 to w7 are set according to the interval from the PID1OK pulse. If the PID1OK pulse is not detected and the PID2OK pulse is detected for the first time, then interval measurement windows w6 and w7 are set according to the position of the PID2OK pulse.

The determination unit 34 within the address information interval measurement unit 26 determines whether or not the detected PIDnOK pulse appears within the corresponding interval measurement window. If so, it is determined that the position of that PIDnOK pulse is correct. This determination result is stored in the address information position determination result hold unit 27.

In the same manner as that of the first embodiment, the address information position determination operation selection unit 28 finally determines a position of PIDnOK pulse, based on at least one of a determination result by the address information position determination unit 25 and a determination result by the address information interval measurement unit 26 described above.

FIG. 9 shows an example in which all four PIDnOK pulses appear within the corresponding prediction windows w1 to w4, and at the same time, and three PIDnOK pulses (n=2 to 4) appear within the corresponding interval measurement windows w5 to w7. In this case, even if the address information position determination operation selection unit 28 selects which of a determination result of the address information position determination unit 25 or a determination result of the address information interval measurement unit 26, the starting position of the recording field can be properly predicted.

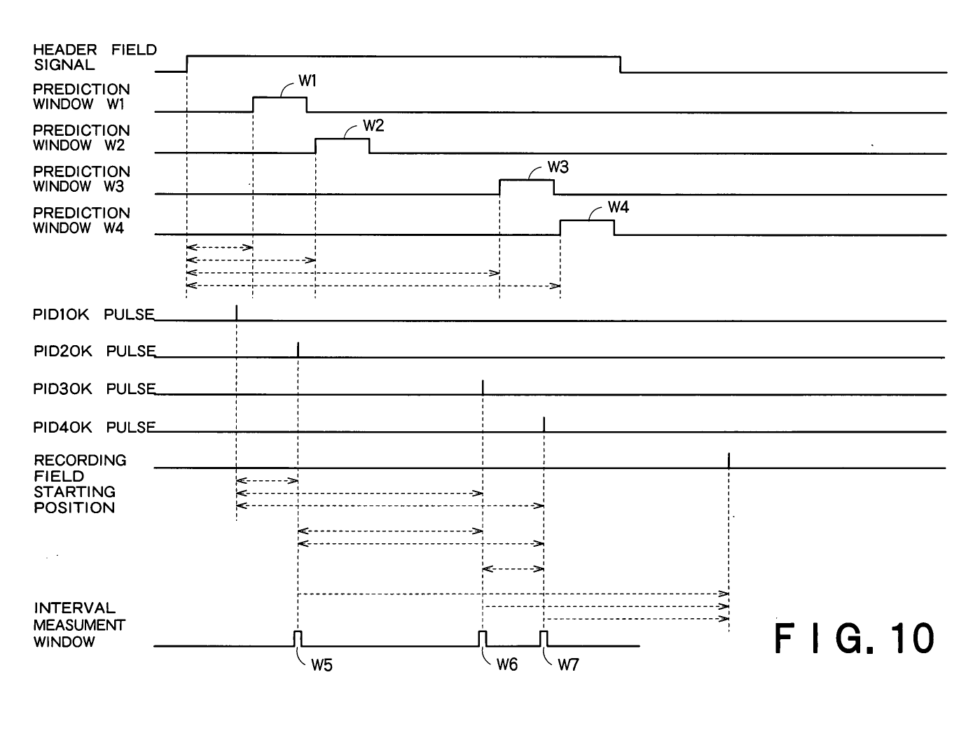

Meanwhile, FIG. 10 is a timing diagram when the PIDnOK pulses do not appear within the corresponding prediction windows. In the case of FIG. 10, none of four PIDnOK pulses appears within the corresponding prediction windows w1 to w4. In this case, in the first embodiment, the starting position of the recording field cannot be predicted. However, the address information interval measurement unit 26 of FIG. 1 according to the present embodiment sets the interval measurement windows w5 to w7 based on first PID1OK pulse. All PIDnOK pulses (n=2 to 4) appear within the corresponding interval measurement windows w5 to w7. Therefore, the address information position determination operation selection unit 28 does not use a determination result of the address information position determination unit 25. Instead, the address information position determination operation selection unit 28 determines that the position of PIDnOK pulse is correct based on a determination result of the address information interval measurement unit 26. Therefore, the starting position of the recording field can be properly predicted.

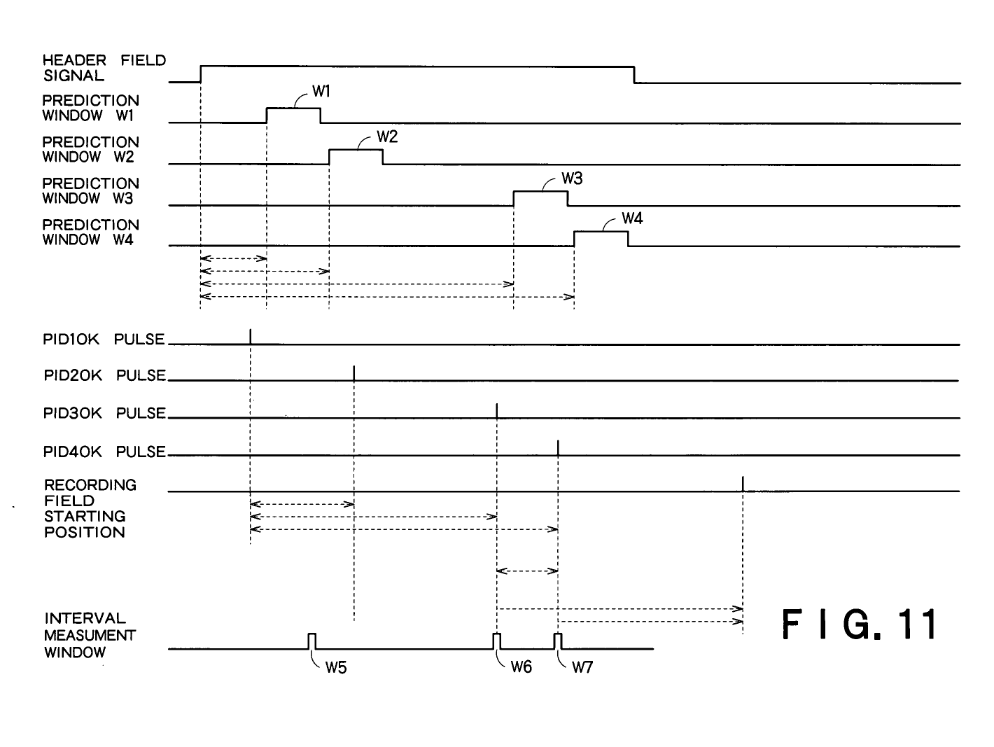

FIG. 11 is a timing diagram when some PIDnOK pulses do not appear within the interval measurement windows. In the case of FIG. 11, the interval measurement windows w5 to w7 are set based on the PID1OK pulse detected for the first time. Second PID2OK pulse appears within the prediction window w2, but does not appear within the interval measurement window w5. Consequently, it can be determined that the position of the PID2OK pulse is highly probably incorrect. Meanwhile, the other PIDnOK pulses (n=3, 4) do not appear within the corresponding prediction windows w3 and w4, but appear within the corresponding interval measurement windows w6 and w7. The interval measurement windows w6 and w7 are set based on the position of the PID1OK pulse. Consequently, it can be determined that the position of PID1OK pulse, PID3OK pulse and PID4OK pulse is highly probably correct. Therefore, the address information position determination operation selection unit 28 determines that the position of PIDnOK pulses (n=1, 3, 4) is correct, and based on that position, the starting position of the recording field is determined.

In this manner, according to the second embodiment, the interval measurement windows for predicting a position of other PIDnOK pulses are set according to an interval from the position of the PIDnOK pulse detected for the first time,. Accordingly, even when a position of PIDnOK pulse cannot be accurately determined using prediction window alone, positions of the PIDnOK pulses can be properly detected. Consequently, the starting position of the recording field and sector address can be highly accurately predicted.

### Third Embodiment

In the second embodiment, there has been explained an example in which positions of the PIDnOK pulses are determined using both prediction window and interval measurement window. However, determination of the PIDnOK pulses may be performed using only the interval measurement window. In this case, the address information position determination unit 25 of FIG. 1 is not needed, and the address information position determination operation selection unit does not perform any selection operation. Instead, the address information position determination operation selection unit performs a position determination based on a determination result of the address information interval measurement unit 26.

In this manner, according to the third embodiment, the interval measurement window is set based on PIDnOK pulse detected for the first time, and position determination of PIDnOK pulses is performed according to whether or not PIDnOK pulse is present within the interval measurement window. Accordingly, the starting position of recording field to be accessed can be predicted with a simple configuration and procedure, compared to the second embodiment.

What is claimed is:

1. An optical disc device, comprising:
a header field detector configured to detect a header field of an optical disc;
a header address information detector which detects a plurality of address information recorded to the header field;
a range setting unit configured to set a range predicted that the plurality of address information is present within the header field;
a position determination unit configured to determine whether the plurality of address information detected by the header address information detector is present within the range set by the range setting unit; and
a starting position prediction unit configured to predict a starting position to be assessed in a recording field arranged subsequent to the header field in the optical disc and a sector address corresponding to the header field based on a determination result of the position determination unit.

2. The optical disc device according to claim 1,
wherein the range setting unit sets a plurality of prediction windows indicating a range predicted that the plurality of address information is present; and
the position prediction unit determines whether the address information is present within each of the plurality of prediction windows.

3. The optical disc device according to claim 2,
wherein the starting position determination unit predicts the starting position and the sector address based on the address information in the prediction windows when the position determination unit determines that the corresponding address information is present in at least one of the prediction windows.

4. The optical disc device according to claim 1,
wherein the optical disc is DVD-RAM; and
the header address information detector detects IDs specifying sector addresses of the optical disc as the plurality of address information.

5. An optical disc device, comprising:
a header field detector configured to detect a header field of an optical disc;
a header address information detector configured to detect a plurality of address information recorded to the header field;
a range setting unit configured to set a range in the header field predicted that the remaining address information within the header field is present, based on an interval from a position of a part of the address information detected by the header address information detector;
a position determination unit configured to determine whether a plurality of address information detected by the header address information detector is present within a range set by the range setting unit; and
a starting position prediction unit configured to predict a starting position to be accessed in a recording field arranged subsequent to the header field in the optical disc.

6. The optical disc device according to claim 5,
wherein the range setting unit sets a plurality of interval measurement windows indicating ranges in the header field predicted that the remaining address information in the header field is present by setting as a starting point a position of a part of the address information detected by the header address information detector; and
the position determination unit determines whether the address information is present within each of the plurality of interval measurement windows.

7. The optical disc device according to claim 6,
wherein the starting position determination unit predicts the starting position and the sector address based on the address information positioned within the interval measurement window when the position determination unit determines that the address information corresponding to at least one of the interval measurement window is present.

8. The optical disc device according to claim 5,
wherein the optical disc is DVD-RAM; and
the header address information detector detects IDs specifying sector addresses of the optical disc as the plurality of address information.

9. An optical disc device, comprising:
a header region detector configured to detect a header field of an optical disc;
a header address information detector configured to detect a plurality of address information recorded to the header field;
a first range setting unit configured to set a range predicted that the plurality of address information is present within the header field;
a first position determination unit configured to determine whether the plurality of address information detected by the header address information detector is present within a range set by the first range setting unit;
a second range setting unit configured to set a range in the header field predicted that the remaining address information in the header region is present based on an interval from a position of a part of the address information detected by the header address information detector;
a second position determination unit configured to determine whether a plurality of address information detected by the header address information detector is present within a range set by the second range setting unit;
a determination result selector configured to select at least one of a determination result of the first position determination unit and a determination result of the second position determination unit; and
a starting position prediction unit configured to predict a starting position to be accessed in a recording field arranged subsequent to the header field in the optical disc based on a determination result of the determination result selector.

10. The optical disc device according to claim 9,
wherein the first range setting unit sets a plurality of prediction windows indicating ranges predicted that the plurality of address information is present; and
the first position determination unit determines whether the address information is present within each of the plurality of prediction windows.

11. The optical disc device according to claim 10,
wherein the starting position prediction unit predicts the starting position and the sector address based on the address information positioned in the prediction window when the determination result selector selects a determination result of the first position determination unit and the first position determination unit determines that the corresponding address information is present within at least one of the prediction windows.

12. The optical disc device according to claim 9,
wherein the second range setting unit sets a plurality of interval measurement windows indicating ranges in the header region predicted that the remaining address information in the header region is present by setting as a starting point a position of a part of the address information detected by the header address information detector; and
the second position determination unit determines whether the address information is present within each of the plurality of interval measurement windows.

13. The optical disc device according to claim 12,
wherein the starting position determination unit predicts the starting point and the sector address based on the address information positioned in the interval measurement window when the determination result selector selects a determination result of the first position determination unit and the second position determination unit determines that the corresponding address information is present within at least one of the interval measurement window.

14. The optical disc device according to claim 9,
wherein the range set by the first range setting unit is broader than a range set by the second range setting unit.

15. The optical disc device according to claim 9,
wherein the optical disc is DVD-RAM; and
the header information detector detects IDs specifying sector addresses of the optical disc as the plurality of address information.
